(19) United States
(12) Patent Application Publication
(10) Pub. No.: US 2025/0284105 A1
(43) Pub. Date: Sep. 11, 2025

(54) LENS ARRAY BASED IMAGING SYSTEM WITH IMPROVED FIELD OF VIEW

(71) Applicant: THE UNITED STATES OF AMERICA, AS REPRESENTED BY THE SECRETARY, DEPARTMENT OF OF HEALTH AND HUMAN, Bethesda, MD (US)

(72) Inventors: Yuanyuan LIU, Rockville, MD (US); Xiaomin LAI, Rockville, MD (US)

(21) Appl. No.: 18/859,972

(22) PCT Filed: Apr. 21, 2023
(86) PCT No.: PCT/US2023/019360

§ 371 Date: Oct. 24, 2024

Related U.S. Application Data
(60) Provisional application No. 63/334,399, filed on Apr. 25, 2022.

(51) Int. Cl. G02B 21/00; G06T 5/50

(52) U.S. Cl. CPC G02B 21/006; G02B 21/0036; G02B 21/008; G06T 5/50; G06T 2200/32

(57) ABSTRACT

An imaging system and method includes a microscope for observing a sample. A light source is arranged to generate light along an optical path of the microscope. A lens array is positioned in the optical path of the microscope, the lens array having a plurality of lenses each with a lens optical axis, the lens optical axes positioned to each capture a separate field of view of the sample. At least one detector is configured to detect the separate fields of view from the lenses. The imaging system is configured to mosaic the detected separate fields of view from each lens to generate an image of the sample.

### CROSS REFERENCE TO RELATED APPLICATIONS

The present application is a U.S. National Phase of International Application No. PCT/US2023/019360 entitled “LENS ARRAY BASED IMAGING SYSTEM WITH IMPROVED FIELD OF VIEW,” and filed on Apr. 21, 2023. International Application No. PCT/US2023/019360 claims priority to U.S. Provisional Patent Application No. 63/334,399 filed on Apr. 25, 2022. The entire contents of each of the above-listed applications are hereby incorporated by reference for all purposes.

### FIELD OF THE TECHNOLOGY

The subject disclosure relates to imaging systems, and more particularly to microscope systems in mesoscale.

### BACKGROUND OF THE TECHNOLOGY

Microscope technology requires the balancing of a number of important design considerations. For example, it should be appreciated that the microscope should be able to capture a large enough field of view (FOV) to properly image an entire sample simultaneously. Obtaining a sufficient FOV also should be balanced against other considerations, such as the image quality, cost, and speed. For example, obtaining a larger FOV can impact the spatial or temporal resolution of the microscope. Therefore, there is an urgent ongoing need in the art to improve existing microscopes, including providing a microscope that allows for large FOV without sacrificing the spatial or temporal resolution.

### SUMMARY

In light of the needs described above, in at least one aspect, the subject technology relates to a microscope that utilizes a lens array to realize a large FOV without tradeoffs on spatial and temporal resolution.

In at least one aspect, the subject technology relates to an imaging system including a microscope for observing a sample. A light source is arranged to generate light along an optical path of the microscope. A lens array is positioned in the optical path of the microscope, the lens array having a plurality of lenses each with a lens optical axis, the lens optical axes positioned to each capture a separate field of view of the sample. At least one detector is configured to detect the separate fields of view from the lenses. The imaging system is configured to mosaic the detected separate fields of view from each lens to generate an image of the sample.

In some embodiments, the lens array is a gradient index (GRIN) lens array. A scanner can be positioned in the optical path between the light source and the lens array and configured to move to change the angle of incidence of light on the lens array. In some embodiments, a dichroic mirror is positioned in the optical path between the scanner and the at least one detector to reflect light returning from the sample to the at least one detector. An additional lens array can be positioned between the dichroic mirror and the at least one detector, the additional lens array configured to focus light from each lens in the GRIN lenses separately to the at least one detector.

In some embodiments, the at least one detector is a plurality of detectors, the plurality of detectors including one detector for each GRIN lens and corresponding to one pixel of the image of the sample. In some cases, a mask pinhole array is positioned near a focal point between the additional lens array and the detector, the mask pinhole array having pinholes corresponding to the focal point of each GRIN lens, the mask pinhole array blocking scattered light around the pinholes. In some embodiments, the imaging system further comprises a shield which blocks scattered light around each detector, the shield defining pinholes therethrough corresponding to a center of one of the detectors. The system can include a second additional plurality of lenses within the shield, including one lens corresponding to each of the detectors within the shield to improve the detection efficiency.

In some embodiments, the scanner is positioned and configured such that movement of the scanner further changes the angle of light returning from the sample to the at least one detector. In some cases, the GRIN lens array includes seven separate GRIN lenses, including a central GRIN lens and six outer GRIN lenses placed around the perimeter of the central lens.

In some embodiments, a pinhole is positioned near the at least one detector, wherein the at least one detector is a single detector. In some cases, a lens is positioned between the detector and the GRIN lens array and configured to focus signals returning through the GRIN lens array through the pinhole and onto the single detector. In that case, the imaging system is configured to use other technologies, for example, time multiplexing such that the single detector collects signals from the GRIN lenses sequentially. In some embodiments, a dichroic mirror is positioned in the optical path between the scanner and the sample, the at least one detector configured to reflect light returning from the sample to the at least one detector. In some cases, the lens optical axes are arranged in parallel.

In at least one aspect, the subject technology relates to an imaging system including a microscope for observing a sample. A light source is arranged to generate light along an optical path of the microscope. A GRIN lens array is positioned in the optical path of the microscope, the GRIN lens array comprising a plurality of lenses each with a lens optical axis. The lens optical axes are arranged in parallel, and each GRIN lens is positioned to capture a separate field of view of the sample. At least one detector is configured to detect the separate fields of view from the GRIN lenses. A control and acquisition system includes a processor and software for generating an image of the sample from signals from the at least one detector. The control and acquisition system are configured to denoise the signals and construct an image of the sample by tiling the separate field of views from each GRIN lens.

In at least one aspect, the subject technology relates to a method of imaging a sample with a microscope. Light is generated with a light source along an optical path of the microscope. The light is passed through a lens array positioned in the optical path of the microscope, the lens array having a plurality of lenses each with a lens optical axis, the lens optical axes positioned to each capture a separate field of view of the sample. At least one detector detects the separate fields of view from the lenses. The detected separate fields of view are mosaicked from each lens to generate an image of the sample.

In some embodiments, the lens array is a GRIN lens array. The method can further include moving a scanner to change the angle of incidence of light on the lens array, the scanner positioned in the optical path between the light source and the lens array. In some embodiments, the method includes reflecting light returning from the sample to the at least one detector with a dichroic mirror positioned in the optical path between the scanner and the at least one detector. In some embodiments, the lens optical axes are arranged in parallel such that light is passed through each lens in parallel.

### BRIEF DESCRIPTION OF THE DRAWINGS

So that those having ordinary skill in the art to which the disclosed system pertains will more readily understand how to make and use the same, reference may be had to the following drawings.

FIG. 1 is a block diagram of an imaging system in accordance with the subject technology.

FIG. 2 is a schematic diagram of an exemplary microscope in accordance with the subject technology.

FIG. 3 is a schematic diagram of a GRIN lens array which can be used in a microscope in accordance with the subject technology.

FIG. 4a is a schematic diagram of an exemplary optical path through a single GRIN lens with the light illuminated along the optical axis in accordance with the subject technology.

FIG. 4b is a schematic diagram of the optical path of a GRIN lens array with the light illuminated along the optical axis.

FIG. 4c is a schematic diagram of another exemplary optical path through a GRIN lens with the light illuminated at an angle with respect to the optical axis in accordance with the subject technology.

FIG. 4d is a schematic diagram of the optical path of a GRIN lens array with the light illuminated at an angle with respect to the optical axis.

FIG. 5 is a simplified diagram showing an exemplary detection optical path through part of the microscope of FIG. 2.

FIGS. 6a-6b are cross-sectional views of various shield and detector array combinations which can be utilized within a microscope in accordance with the subject technology.

FIG. 7 is a schematic diagram of another exemplary microscope in accordance with the subject technology.

FIG. 8 is a schematic diagram of another exemplary microscope in accordance with the subject technology.

FIGS. 9a-9f are cross-sectional views of various GRIN lens arrays which can be implemented as part of a microscope in accordance with the subject technology.

### DETAILED DESCRIPTION

The subject technology overcomes many of the prior art problems associated with microscope systems. In brief summary, the subject technology provides a microscope with a lens array (e.g. of gradient-index (GRIN) lenses, glass lenses, plastic lenses, lenses simulated by wavefront modulators such as spatial light modulator (SLM), or other lenses which could focus light) to image a sample. The advantages, and other features of the systems and methods disclosed herein, will become more readily apparent to those having ordinary skill in the art from the following detailed description of certain preferred embodiments taken in conjunction with the drawings which set forth representative embodiments of the present invention. Like reference numerals are used herein to denote like parts. Further, words denoting orientation such as “upper”, “lower”, “distal”, and “proximate” are merely used to help describe the location of components with respect to one another. For example, an “upper” surface of a part is merely meant to describe a surface that is separate from the “lower” surface of that same part. No words denoting orientation are used to describe an absolute orientation (i.e. where an “upper” part must always be at a higher elevation).

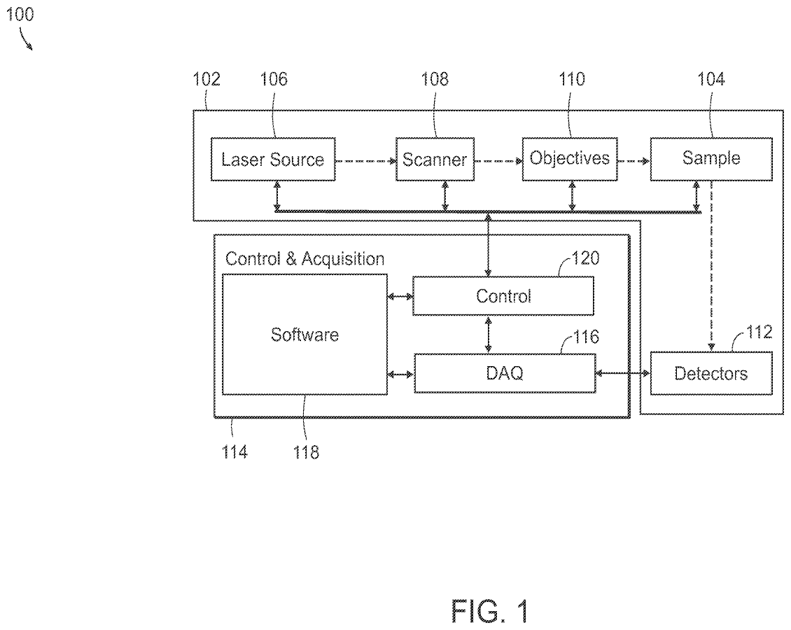

Referring now to FIG. 1, a block diagram of a simplified imaging apparatus 100 in accordance with the subject technology is shown. The imaging apparatus 100 includes a microscope 102 for viewing a sample 104. The microscope 102 includes a laser source 106 to illuminate the sample 104 and one or more scanners 108 to change the angle of the light as it passes to the sample 104. In the embodiment shown, the scanner 108 directs the light through objectives 110 before passing to the sample 104. Observed signals from the sample 104 are recorded by detectors 112.

The microscope 102 is connected to a control and acquisition system 114, which can handle all necessary input, output, and processing functions of the imaging apparatus 100. The control and acquisition system 114 can include a controller, an analog-to-digital converter (ADC), software, and other necessary parts to carry out the functions of the imaging system 100. In this embodiment, the analog signals from detectors 112 can be amplified by a multi-channel amplifier and then converted to digital signals by data acquisition (DAQ) systems 116 with onboard processing by a field programmable gate array.

The signals are then delivered to software 118 for further processing, such as denoise and reconstruction. The software 118 is ultimately responsible for mosaicking the fields of view based on the signals of multiple lenses in a lenses array, as discussed in more detail below, to generate images of the sample 104.

The control and acquisition system 114 can also include a control module 120 responsible for coordinating multiple devices and transferring signals between them. It should be understood that the control and acquisition system 114 can include other components to carry out the functions described herein, including a processor and software specifically configured to execute instructions in accordance with the functions of the control and acquisition system 114. For example, the control and acquisition system 114 can include several acquisition/control cards that have multiple I/O ports which can be used to control and synchronize devices. Off-the-shelf software can be used to control and synchronize the data acquisition process, as is realized in traditional scanning microscope systems such as laser scanning confocal microscopes or two-photon microscopes. Based on this, for multi-channel data acquisition, the number of channels of the software 118 will be updated to the one that is needed.

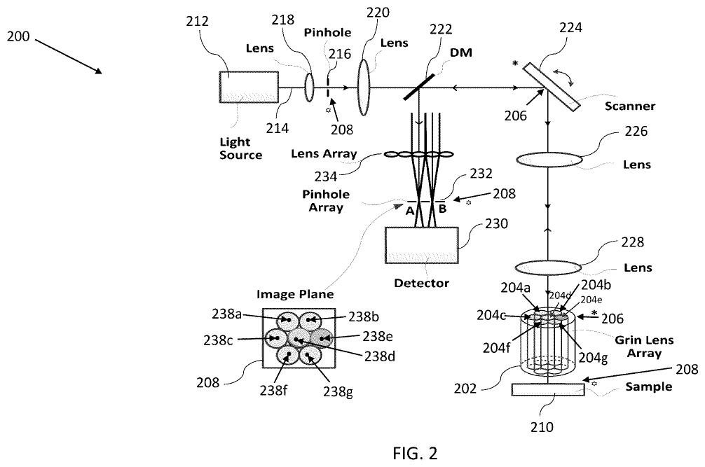

Referring now to FIG. 2, an exemplary microscope in accordance with the subject technology is shown. The microscope 200 can function similar to the microscope 102, and be used as part of a similar optical imaging apparatus 100, except as otherwise shown and described. In general, the microscope 200 utilizes a GRIN lens array 202 in an arrangement to replace a typical microscope objective, allowing for a large FOV without sacrificing spatial and temporal resolution. This is realized by combining scanning and descanning techniques with the GRIN lens array 202, to separate the signal from each lens 204a-204g (generally 204) within the GRIN lens array 202. The structure of the microscope 200 is simplified for showing purpose and conjugate planes are indicated using like reference numerals (plane 206 and plane 208).

A sample 210 is positioned on a substrate for viewing with the microscope 200. A light source 212, which could be a visible laser, femtosecond laser, LED, or the like is arranged to generate light along an optical path 214 of the microscope 200. Note that while one optical path 214 is described for simplicity, it will be detailed below that the GRIN lens array 202 actually utilizes a number of separate optical paths for each lens 204 in the array 202. The light is spatially filtered by a pinhole 216 to generate a point light source, which will later be imaged onto the sample 210. Other suitable means could also be used to generate the point light source, such as optical fibers. After collimating and expanding through lenses 218, 220, the light will pass through a dichroic mirror 222 (DM) and then be reflected by scanners 224. Notably, the DM 222 could be replaced by other beam splitters, particularly if aimed to record signals that are non-fluorescent.

Next, the plane 206 of scanners 224 is relayed to the back-aperture plane 206 of the GRIN lens array 202 by using two lenses 226, 228. Light will be focused onto the sample 210 through the GRIN lenses array 202. Based on the number “n” of GRIN lenses 204 that are used in the array 202, there will be “n” focuses generated simultaneously on the sample plane 208, as discussed in more detail below. The returning light passes back through the GRIN lens array 202 and is redirected by the scanner 224. The DM 222 splits the returning light from the original optical path 214, the light passing through another lens array 234 and then a pinhole array 232 before receipt by the detector array 230. The final image generated from the microscope 200 can be formed by combining the images from the light collected from the individual lenses 204 of the GRIN lens array 202.

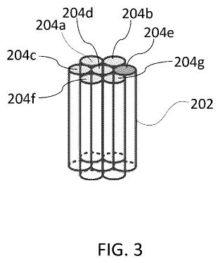

The GRIN lens array 202 used in the microscope 200 is composed of multiple GRIN lenses 204, as shown in FIG. 3. In the example shown, the GRIN lens array 202 uses seven separate lenses 204 each with a circular cross section. The lenses 204 are arranged with a central lens 204d, and the remaining lenses 204a-204c, 204e-204g uniformly around the perimeter of the central lens 204d. The GRIN lenses 204 are arranged next to each other with their optical axes positioned in parallel. The GRIN lenses 204 are aimed to be arranged in a way that the individual lens is responsible for individual FOV, which could be located at any given position in a three-dimensional space. Thus, for another example the GRIN lenses 204 could also be placed at any given position in a three-dimensional matrix, randomly and separately. The pitch of the GRIN lenses 204 are set as about ¼+½*m where m is an integer. Thus, the GRIN lenses 204 are used to focus or collect light instead of relaying the sample plane 208 beneath the GRIN lens array 202 to its top.

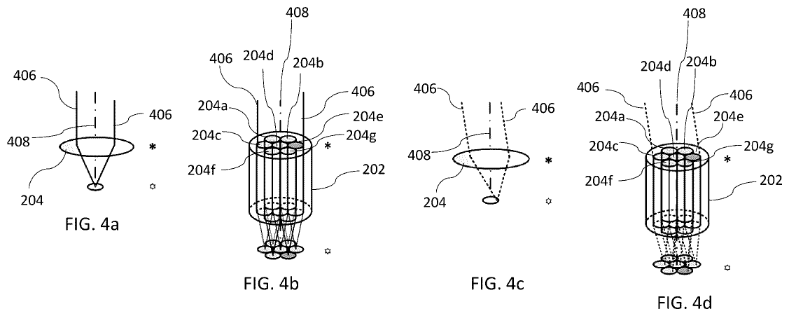

The microscope 200 is designed to allow individual GRIN lens 204 to focus or collect light from their own field of view (FOV). Exemplary light 406 representing incident beams for lenses 204 are shown in FIGS. 4a-4d and discussed in more detail below. This creates at least two advantages. First, by mosaicking the light 406 from the individual FOVs of the different lenses 204, the total FOV achieved by the system is s*n, where's is the FOV of individual GRIN lens 204 and n is the quantity of GRIN lenses 204 used in the array. Thus, the total FOV can be enlarged either by increasing the diameter(s) or quantity (n) of GRIN lenses 204. Second, because the light collection ability depends on a single lens, the spatial resolution equals to that of individual GRIN lenses 204, which is determined by its numerical aperture (NA). Therefore, unlike conventional microscope objectives, the spatial resolution is not reduced when enlarging the FOV. While the GRIN lens array 202 has been found to be particularly advantageous, it should be understood that another lens array which functions similar to the GRIN lens array 202 described herein could also be used.

The scanners 224 of the microscope 200 are designed to move the focuses by changing the angles of light when it incidents on GRIN lenses 204. This process is known as scanning. The scanners 224 can be galvanometer scanners, resonant scanners, spatial light modulator (SLM), digital micromirror device (DMD), micro-electro-mechanical system (MEMS), acousto-optic deflectors (AOD) or other devices which are capable of changing the direction of light. Light beams directed to each GRIN lens can be controlled by the same or separate scanners 224. The effect of scanning on light within the system is illustrated in FIGS. 4a-4d. More particularly, FIG. 4b shows light 406 passing through the GRIN lenses 204 in a first orientation, parallel to the central axis 408 of the GRIN lens array 202. FIG. 4a shows an exemplary path of the light 406 of FIG. 4b passing through an individual lens 204 within the GRIN lens array 202. FIG. 4d shows light 406 passing through the GRIN lens array 202 at an oblique angle (with respect to the central axis 408) due to scanning. FIG. 4c shows an individual lens 204 of the array 202 shown in FIG. 4d.

The scanning process can employ other known scanning strategies used in confocal or two-photon (2P) systems, specific or all locations across the FOV of individual GRIN lenses 204 will be reached. Since the scanning through multiple GRIN lenses 204 is accomplished simultaneously, the time spent on scanning of the whole FOV equals to that on individual ones. That means, if the time spent on scanning the FOV(s) of single GRIN lens 204 is t, the time spent on scanning the whole FOV (n*s) is also t, as the light beams 406 are scanning simultaneously. Thus, the temporal resolution is not reduced when enlarging the FOV by using multiple GRIN lens 204.

Notably, various scanning processes can be employed by the microscope 200, including random, raster, or other customized processes. In the embodiment shown, during scanning, all parts of the microscope 200 except for scanners 224 remain immobilized, and there is no movement between the sample and objective. Alternatively, the microscope 200 can use sample scanning instead of light beam scanning. In that case, the direction of light beam that incidents onto GRIN lenses 204 is fixed, while the sample 210 or lens array 202 is moving, for example, in a 2D, or 3D manner.

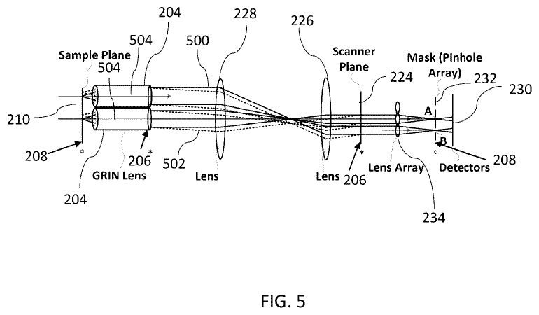

Referring now to FIG. 5 a simplified schematic diagram shows an exemplary part of the path of signals from the sample 210 through the microscope 200. The responding signals from individual focus are collected by corresponding GRIN lenses 204. These signals could be fluorescence or other light induced signals, as well as reflected or transmitted light. Here, fluorescent signals are used as an example. In FIG. 5, signals 500 (solid lines) represent lights from the center of individual FOVs, while signals 502 (dotted lines) represents lights from another location in the same FOVs.

Collected fluorescent signals are then relayed back to the scanner 224, i.e. the back-aperture plane 206 of GRIN lenses array 202 will be relayed back to the conjugate scanner plane 206. After propagating through the scanners 224, the locations, propagating directions, and sizes of the beams from each GRIN lens 204 are fixed yet separatedError! Reference source not found. Particularly, for individual lenses 204, lights from different locations coincide after scanner 224, (i.e. light 500, 502 coincide after the scanner 224). This means the propagating direction will not change during scanning. This process is called descanning. More importantly, signals from individual GRIN lenses 204 are separated after descanning. Therefore, a second lens array 234 includes a number of individual lenses each focusing a respective beam separately. The diameter of lenses in the second lens array 234 matches the size of the image of individual GRIN lens 204.

As the location and direction of lights from each GRIN lens 204 are fixed after descanning, the location of focus is then fixed on the image plane 208 of the second lens array 234. This means, for each GRIN lens 204, signals on the image plane 208 always reaches the same point during scanning. For example, the image location of the light from each GRIN lens is fixed at a corresponding point 238a-238g (generally 238) while scanning. A mask pinhole array 232 is placed at the focus point in the example shown. The mask pinhole array 232 contains a pinhole array with different pinholes located at different focus, corresponding to the lenses 204. The pinhole array 232 will reject light scattered from sample locations other than its conjugated focus, similar to pinholes used in confocal microscope systems, which will improve the sectioning ability and signal-to-noise ratio (SNR). Furthermore, using pinholes reduces potential crosstalk between individual GRIN lenses 204. The detector array 230 (e.g. photo-sensitive array) is located behind the mask pinhole array 232 to record optic signals. Signals from each GRIN lens 204 are recorded separately in the detector array 230. Of note, signals could also be collected using fibers and then be delivered to different pixels, or different detectors. The final image is a combination of these collected signals.

If n GRIN lenses 204 are used in the microscope 200 (relay lenses aside) there will be n parallel optical axes (one for each GRIN lens 204). For each pairing of a GRIN lens 204 and pinhole, centers are formed located on their own optical axis. In FIG. 5, only two optical axes 504 of two GRIN lenses 204 are shown for simplicity. If the relay lenses are well constructed, the off-axis aberrations are significantly less when compared to conventional methods under the same FOV. It should be understood that the pinhole 216 and pinhole arrays 232 shown herein are recommended and advantageous, but are not absolutely necessary if there are no needs to improve the section abilities or SNR. This imaging method can also be combined with other scanning strategies such as line scanning, multi-foci scanning and others to further improve the speed, image quality or other parameters.

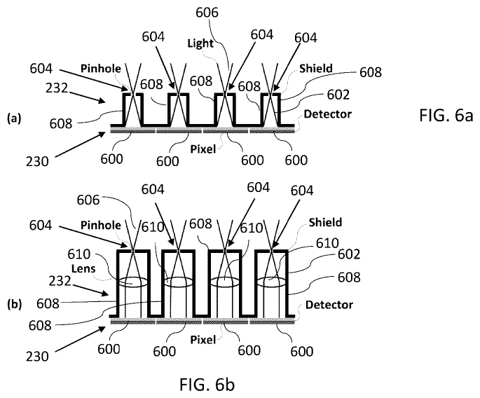

Furthermore, when individual detectors within the detector array 230 are close to each other, such as these pixels of EMCCD, or multianode PMT, signal crosstalk between pixels or detectors could exist. This crosstalk could be decreased by increasing the distance between focuses on the image plane. Another way is to use a shield with small chambers to keep the signal away from reaching other detectors (or pixels), as shown in FIGS. 6a-b.

Referring now to FIGS. 6a-b, embodiments of a detector array with individual detectors 600, or a detector with individual pixels 600, each utilizing a shield 602 are shown. On top of this shield 602, there are multiple pinholes 604, including one for each detector 600 at a center of the corresponding detector 600. Light 606 passes through individual pinholes 604 corresponding to the center of each detector 600, with the shield 602 forming small chambers around each detector 600. Each detector 600 can correspond to one pixel in the final image of the sample 210. Taking the multinode PMT as an example, the pixel size can be 6 mm. The distance between individual chambers 608 formed by the shield 602 is thus set as 6 mm while the width of chamber 608 is, for example, 2 mm. Because light signals are restricted within individual chambers 608, theoretically no signals will fall onto the junction of adjacent pixels 600 and the crosstalk is then reduced. In addition, lenses 610 can also be placed in front of detectors to improve the collection efficiency of light, as shown in FIG. 6b. An alternative method of reducing crosstalk between detectors 600 is, as previously mentioned, using fibers to deliver the signal from each GRIN lens 204 to the separated detectors 600. Furthermore, this system can also be employed in conjunction with movement between the sample and objective, which will further enhance the FOV without altering the GRIN lens array 202.

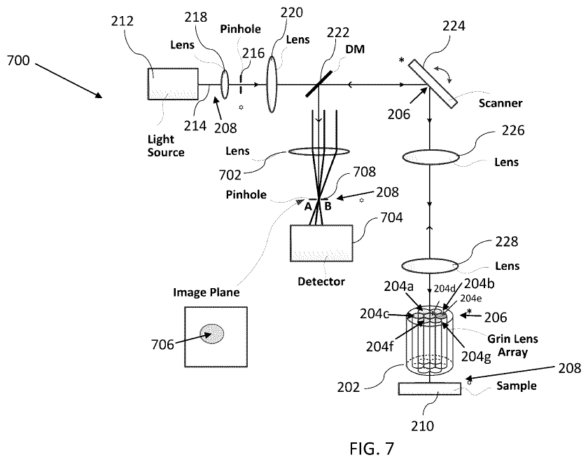

Referring now to FIG. 7, another exemplary embodiment of a microscope 700, in accordance with the subject technology, is shown. The microscope 700 includes similar components, and can function similarly, to the microscope 200, except as otherwise shown and described. In the microscope 200, a second lens array 234 and detector array 230 of multiple detectors are adopted to realize large FOV imaging without tradeoffs on spatial and temporal resolution. By contrast, in the microscope 700, the second lens array 234 is replaced by a single lens 702 and the detector array 230 is replaced by a single detector 704. The single lens 702 and single detector 704 are used to focus and record signals after descanning. In this microscope 700, light from all GRIN lenses 204 will be focused to the same location 706 (i.e. representing overlapping light from the difference GRIN lenses 204). The signals from each GRIN lens 204 are focused through a single pinhole 708 and combined on the detector 704. In this case, other strategies, for example, time multiplexing methods can be used, to separate these signals. To realize time multiplexing, other devices can be incorporated such as a spatial light modulator, or separate scanners, to control the on and off status of individual GRIN lenses 204. In other words, signals from individual GRIN lenses 204 will be collected sequentially by the detector 704. This strategy allows large FOV without compromising spatial resolution. The temporal resolution, however, might be reduced.

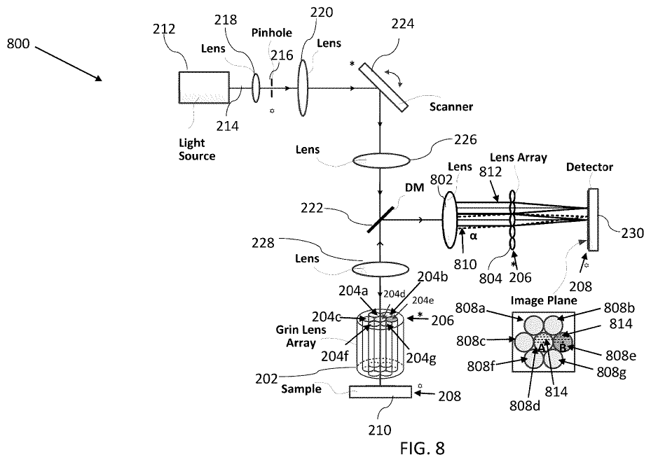

Referring now to FIG. 8, another exemplary embodiment of a microscope 800, in accordance with the subject technology, is shown. The microscope 800 includes similar components, and can function similarly, to the microscope 200, except as otherwise shown and described. Unlike the microscope 200, there is no descanning in the microscope 800. This allows less signal loss as detector array 230 is placed closer to the sample 210, making it more suitable for detecting weak signals. In this embodiment, lights from sample 210 are collected and then directed to a second lens 802 and lens array 804, with a dichromatic mirror 222 or a beam splitter. The back aperture of the GRIN lens array 202 is then relayed to a plane 206 where the second lens array 804 is located (line planes being marked with like reference numbers). The lens array 804 will focus lights from GRIN lenses 204 into detectors within the detector array 230. Different from the microscope 200 where descanning is adopted, in microscope 800, for each GRIN lens 204, imaging points from different sample locations will locate at different places on the image plane 208. This means, when scanning, the focusing point will move (or scan) on the detector array 230. Exemplary indicators 808a-808g are shown on the image plane 208 corresponding to the respective GRIN lenses 204a-204g. Dotted lines 810 through the lens array represent the change of signal angles during scanning (compared to solid lines 812), with dots 814 on the image plane representing exemplary signal movement during scanning. Thus, pinholes cannot be used to reject the out-of-focus signals and the size of each detector in the detector array 230 should be large.

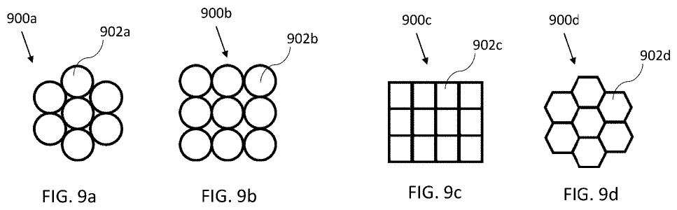

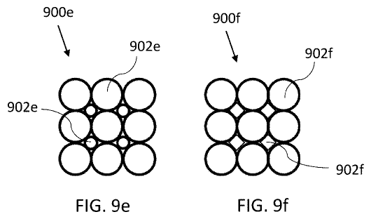

Referring now to FIGS. 9a-9f, exemplary cross sections of GRIN lens arrays 900a-900f (generally 900) are shown, the arrays 900 each comprised of a plurality of individual GRIN lenses 902a-902-f (generally 902). It should be understood that the arrays 900 are exemplary only, and other arrangements could also be used within a microscope designed in accordance with the subject technology. In some examples, the GRIN lenses arrays 900 can be arranged in various shapes, such as circular (900a, 900d), square (900b, 900c, 900e, 900f), or other shapes, with the total number of GRIN lenses 902 varying as needed. The cross section of each individual GRIN lens 902 could also be different shapes, including circular (902a, 902b, 902e, 902f), rectangular (902c), square, hexagonal (902d), or others. As shown in FIGS. 9e-9f, the array 900 can also include GRIN lenses 902e, 902f with varying size, such as a first grouping of larger lenses of a first size and a second grouping of lenses of a smaller size. The relative positions between individual GRIN lenses are changeable. They can be placed separately instead of being adjacent to each other. For example, multiple lenses can be placed to focus on different regions within the sample to record the signals from these regions simultaneously.

The objective (e.g. GRIN lens arrays) of the system is changeable. In some cases, several objectives of different parameters, such as size, numerical aperture, and number of lenses can be used. Further, the system can process the light using a number of separate channels, including up to 64 channels, with one channel for each lens in the lens array. A rotary stage can also be used to shift between different arrays as needed.

Notably, while GRIN lenses are discussed throughout this disclosure, and have been found to be one advantageous type of lens array which can be used as part of the systems described herein, it should be understood that other lens arrays may also be sued. For example, the systems described herein could use glass lenses, plastic lenses, lenses simulated by wavefront modulators such as spatial light modulators, or other lenses which could focus light, instead of a GRIN lens array.

All orientations and arrangements of the components shown herein are used by way of example only. Further, it will be appreciated by those of ordinary skill in the pertinent art that the functions of several elements may, in alternative embodiments, be carried out by fewer elements or a single element. Similarly, in some embodiments, any functional element may perform fewer, or different, operations than those described with respect to the illustrated embodiment. Also, functional elements shown as distinct for purposes of illustration may be incorporated within other functional elements in a particular implementation.

While the subject technology has been described with respect to preferred embodiments, those skilled in the art will readily appreciate that various changes and/or modifications can be made to the subject technology without departing from the spirit or scope of the subject technology. For example, each claim may depend from any or all claims in a multiple dependent manner even though such has not been originally claimed.

What is claims is:

1. An imaging system including a microscope for observing a sample comprising:
a light source arranged to generate light along an optical path of the microscope;
a lens array positioned in the optical path of the microscope, the lens array comprising a plurality of lenses each with a lens optical axis, the lens optical axes positioned to each capture a separate field of view of the sample; and
at least one detector configured to detect the separate fields of view from the lenses,
wherein the imaging system is configured to mosaic the detected separate fields of view from each lens to generate an image of the sample.

2. The imaging system of claim 1, wherein the lens array is a gradient index (GRIN) lens array.

3. The imaging system of claim 2, further comprising a scanner positioned in the optical path between the light source and the lens array and configured to change the angle of incidence of light on the lens array.

4. The imaging system of claim 3, further comprising a dichroic mirror positioned in the optical path between the scanner and the at least one detector to reflect light returning from the sample to the at least one detector; and further comprising an additional lens array positioned between the dichroic mirror and the at least one detector, the additional lens array configured to focus light from each lens in the GRIN lenses separately to the at least one detector.

5. (canceled)

6. The imaging system of claim 4, wherein the at least one detector is a plurality of detectors, the plurality of detectors including one detector for each GRIN lens.

7. The imaging system of claim 6, wherein each GRIN lens corresponds to one subfield-of-view of the image of the sample.

8. The imaging system of claim 6, further comprising a mask pinhole array positioned near a focus between the additional lens array and the detector, the mask pinhole array having pinholes corresponding to the focus of each GRIN lens, the mask pinhole array blocking scattered light around the pinholes.

9. The imaging system of claim 3, further comprising a dichroic mirror positioned in the optical path between the scanner and the at least one detector to reflect light returning from the sample to the at least one detector, wherein the imaging system further comprises a shield which blocks scattered light around each detector, the shield defining pinholes therethrough corresponding to a center of one of the detectors, and a second additional plurality of lenses within the shield, including one lens corresponding to each of the detectors within the shield.

10. (canceled)

11. The imaging system of claim 3, wherein the scanner is positioned and configured such that movement of the scanner further changes the angle of light returning from the sample to the at least one detector.

12. The imaging system of claim 2, wherein the GRIN lens array includes seven separate GRIN lenses, including a central GRIN lens and six outer GRIN lenses placed around the perimeter of the central lens.

13. The imaging system of claim 3, further comprising:
a pinhole positioned near the at least one detector, wherein the at least one detector is a single detector; and
a lens positioned between the detector and the GRIN lens array and configured to focus signals returning through the GRIN lens array through the pinhole and onto the single detector,
wherein the imaging system is configured to use a time multiplexing technique such that the single detector is capable of distinguishing the signals from the GRIN lenses.

14. The imaging system of claim 3, further comprising a beam splitter positioned in the optical path between the scanner and the sample.

15. The imaging system of claim 13, wherein the beam splitter comprises a dichroic mirror configured to reflect light returning from the sample to the at least one detector.

16. (canceled)

17. An imaging system including a microscope for observing a sample comprising:
a light source arranged to generate light along an optical path of the microscope;
a gradient index (GRIN) lens array positioned in the optical path of the microscope, the GRIN lens array comprising a plurality of lenses each with a lens optical axis, the lens optical axes arranged in parallel and each GRIN lens positioned to capture a separate field of view of the sample;
at least one detector configured to detect the separate fields of view from the GRIN lenses; and
a control and acquisition system, including a processor and software for generating an image of the sample from signals from the at least one detector, the control and acquisition system configured to denoise the signals and construct an image of the sample by mosaicking the separate field of views from each GRIN lens.

18. A method of imaging a sample with a microscope comprising:
generating light, with a light source, along an optical path of the microscope;
passing the light through a lens array positioned in the optical path of the microscope, the lens array comprising a plurality of lenses each with a lens optical axis, the lens optical axes positioned to each capture a separate field of view of the sample;
detecting, with at least one detector, the separate fields of view from the lenses; and
mosaicking the detected separate fields of view from each lens to generate an image of the sample.

19. The method of claim 18, wherein the lens array is a gradient index (GRIN) lens array.

20. The method of claim 19, further comprising moving a scanner to change the angle of incidence of light on the lens array, the scanner positioned in the optical path between the light source and the lens array.

21. The method of claim 20, further comprising directing light returning from the sample to the at least one detector with beam splitter positioned in the optical path between the scanner and the at least one detector.

22. The method of claim 21, wherein the beam splitter comprises a dichroic mirror.

23. The method of claim 18, wherein the lens optical axes are arranged in parallel such that light is passed through each lens in parallel.
